(19) United States
(12) Patent Application Publication
(10) Pub. No.: US 2004/0114374 A1
(43) Pub. Date: Jun. 17, 2004

(54) Lens guard retaining device

(76) Inventor: Patrick Wilfred Gaumont, Houston (CA)

Correspondence Address: ANTONY C. EDWARDS, SUITE 800, 1708 DOLPHIN AVENUE, KELOWNA, BC, V1Y 9S4, CA

(21) Appl. No.: 10/318,263

(22) Filed: Dec. 13, 2002

(51) Int. Cl. F21V 15/00

(52) U.S. Cl. 362/376; 362/277; 362/390

(57) ABSTRACT

The lens guard retaining device for retaining a cover over a lens mounted to a light housing, includes a criss-cross array or web of at least two, that is, first and second flexible straps. Each flexible strap has oppositely disposed cover mounts mounted at opposite ends thereof. The cover mounts are adapted to releasably engage with edges of the cover when adjacent the lens and when the array or web is wrapped around a back of the housing opposite the lens. Each flexible strap includes a strap tensioning means mounted or positioned along the strap for releasable tensioning of each flexible strap once the cover mounts are engaged with the cover. The array or web is thereby selectively and releasably tensionable onto and over the back of the housing to evenly tension the cover onto the lens.

### FIELD OF THE INVENTION

This invention relates to covers for lights such as lens guards generally and in particular to a means, such as a plurality of flexible straps, for retaining a cover such as a lens guard over the lens of a light housing to reduce accidental breakage of the lens from impact from stones or like objects.

### BACKGROUND OF THE INVENTION

Sources of illumination are often required to be mounted in locations, such as on automobiles, where there is a high risk of lens damage such as auxiliary driving lights mounted on vehicles. Other lighting sources such as flood lights mounted in school yards and other public locations. To prevent such damage, lens guards manufactured from impact resistant materials such as plastic or wire mesh are in common use. However such guards are usually difficult to install, generally requiring special tools and a degree of expertise. Further, such guards may be easily dislodged through impact or vibration such as may be encountered when used on off-road vehicles. When such lens guards become dislodged, the effectiveness of the guard is obviously greatly reduced.

The presently available lens guards are somewhat difficult to install, and as a consequence, are equally inconvenient and time consuming to remove when lens cleaning or light maintenance is required.

In the prior art the applicant is aware of U.S. Pat. No. 4,556,931 which issued Dec. 3, 1985 to Wheatly for a Lens for Front End Panel of Automotive Vehicle. Wheatly discloses a filler housing having a bezel at its perimeter adapted to fit a headlight opening in the front of the vehicle. A separate lens is fitted within the filler housing by strips of hook and loop fasteners. The applicant is further aware of U.S. Pat. No. 4,445,165, which issued Apr. 24, 1984 to Sherwood for a Mounting Means for Headlight-Protective Screens. Both Wheatly and Sherwood teach sophisticated means for securing a protective device to a body of an automobile. These devices appear expensive, difficult to install and remove and generally do not address the need for a protective device which can be secured directly over the lens of a light housing.

This application discloses a resilient, unitary, annular grommet, which retains a headlight-protecting screen. The grommet is adapted for retention within a headlight-opening formed within the forward portion of a vehicle body. It is an object of the present invention, therefore, to provide an inexpensive and simple to use lens guard retaining device, which is usable with light housings of different shapes and which will securely fastening a protective guard over the lens of a light housing.

It is a further object of the present invention to provide a lens guard retaining device which may be tensioned to enable the lens guard to generally exert pressure uniformly against the exterior surface lens so as to resist accidental displacement through impact.

A further object of the present invention is to provide a lens guard retaining device which facilitated simple and easy removal of a lens guard for lens cleaning and light maintenance.

### SUMMARY OF THE INVENTION

The present invention is a device for holding a cover over a lens. For example the cover may be a wire or mesh lens guard and the retaining device may incorporate in one embodiment a flexible cross harness and a plurality of separate, elongated retaining straps. The cross harness has a pair of equal length arms secured together at their medial point, so that the arms extend at right angles to one another. The distal end of each cross arm is looped back upon itself and secured so as to retain a buckle or ring within a looped portion so created.

The elongated retaining straps are also flexible. A hook is secured to one end of each strap. The hooks may incorporate a safety catch to close the hook releasably. Hook and loop fastener material are mounted to the ends of the straps opposite the hooks, on the side opposite to the side of the hook opening.

In summary the lens guard retaining device of the present invention for retaining a cover over a lens mounted to a light housing, includes a criss-cross array or web of at least two, that is, first and second flexible straps. Each flexible strap has oppositely disposed cover mounts mounted at opposite ends thereof. The cover mounts are adapted to releasably engage with edges of the cover when adjacent the lens and when the array or web is wrapped around a back of the housing opposite the lens. Each flexible strap includes a strap tensioning means mounted or positioned along the strap for releasable tensioning of each flexible strap once the cover mounts are engaged with the cover. The array or web is thereby selectively and releasably tensionable onto and over the back of the housing to evenly tension the cover onto the lens.

The array or web may include a “+”-shaped web portion. The web portion may include a central cross harness at the center of the web.

Each of the flexible straps may include a pair of flexible retaining straps releasably mounted, so as to be oppositely disposed, to opposite ends of the cross harness, so as to dispose the cover mounts at distal ends of the retaining straps when mounted to the cross harness. The cover mounts may be hooks, and may include safety clips to resiliently hold closed the hooks so as to releasably latch the hooks onto the edges of the cover when mounted over the lens.

The strap tensioning means may include a buckle mounted on each end of the cross harness. A length of one end of each of the retaining straps may be journalled through a corresponding buckle so as to buckle the retaining straps to the cross harness. The ends of retaining straps may have hook and loop fasteners mounted thereto for releasable buckling of the retaining straps to the cross harness.

### BRIEF DESCRIPTION OF THE DRAWINGS

FIG. 1, is an exploded front perspective view of a protective lens cover and a portion of the retaining device of the present invention.

FIG. 2 is a rear elevation view of a light with the retaining device of FIG. 1 positioned thereon.

FIG. 3 is a perspective view of a retaining strap of the retaining device of FIG. 2.

FIG. 4 is a perspective view of the cross harness of the retaining device of FIG. 2.

FIG. 5 is a partially cut away plan view of the retaining strap of FIG. 3.

FIG. 6 is a sectional view taken on line 6-6 of FIG. 5.

### DETAILED DESCRIPTION OF EMBODIMENTS OF THE INVENTION

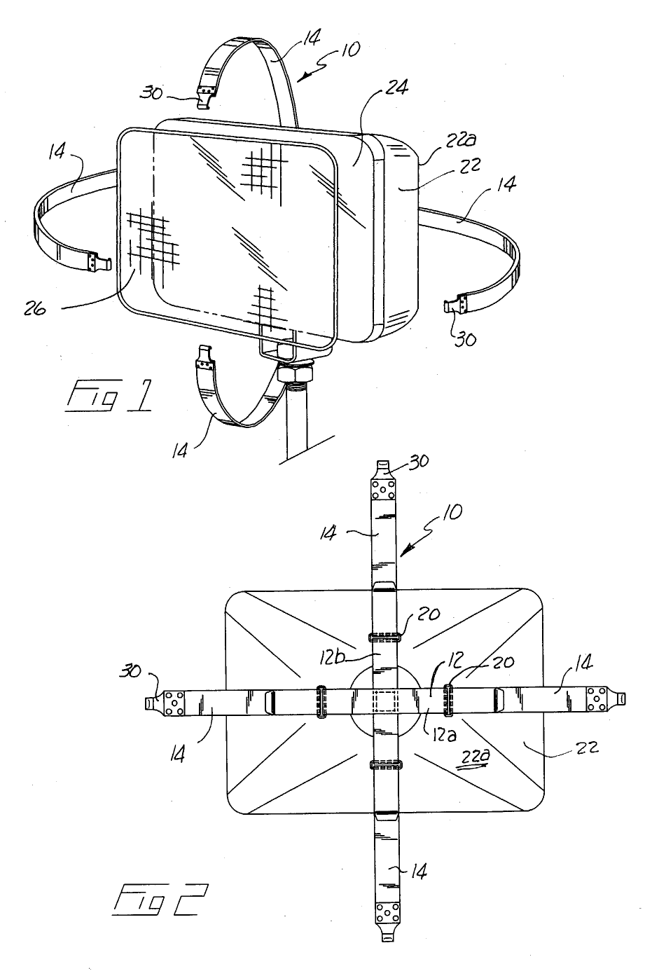

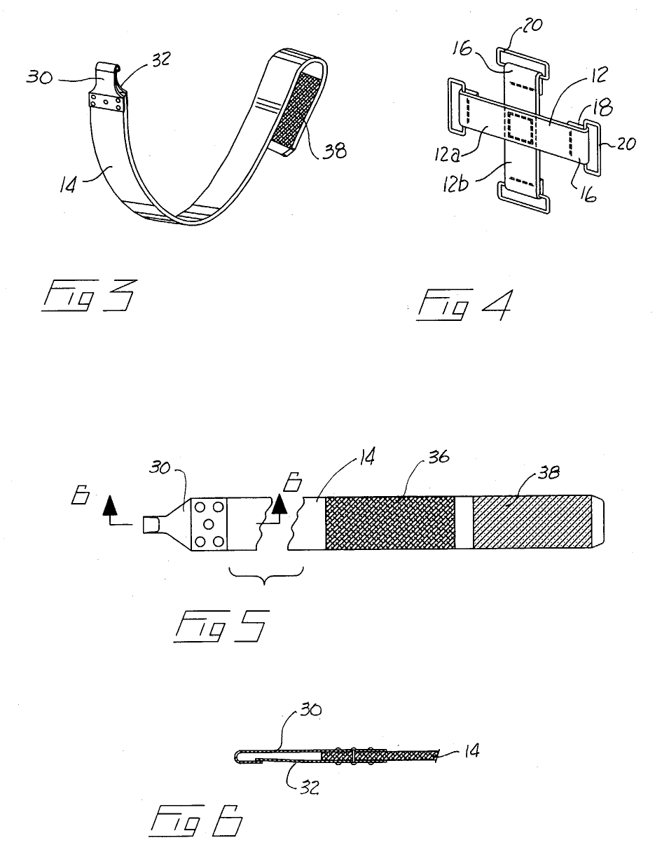

With reference to drawing FIGS. 1-6, wherein similar characters of reference denote corresponding parts in each view, the lens guard retaining device 10 of the present invention comprises, that is, includes, flexible webs having criss-cross array of webbing elements or straps forming, at least in part a “+”-shaped web. The web may include a cross harness 12 and a plurality of separate, elongated flexible retaining straps 14. The cross harness 12 may be manufactured from nylon strapping, fabric or other flexible material. Harness 12 may be constructed of a pair of separate, equal length straps 12a and 12b secured together at their medial point by stitching or other fastening means so that the arms of the straps extend at right angles to one another. These straps may be ¾ inch wide and 1½ inch in length, although this is not intended to be limiting. The distal end 16 of each cross arm strap 12a and 12b is looped back upon itself (as best seen in FIG. 4) and secured as by stitching or other fastening to retain within the loop 18 so created, a rectangular metal or nylon or otherwise rigid buckle such as ring 20. Cross harness 12 is positioned at the rear side 22a of a light housing 22 when in use. That is, on the side opposite to the lens 24 when lens 24 is mounted on housing 22.

A plurality of elongated retaining straps 14 are provided which firmly hold a protective lens guard 26 against lens 24. The length of retaining straps 14 may vary to suit the size and shape of light housing 22. A spherical light housing, for example, may have pairs of retaining straps of equal length while a rectangular housing may have retaining straps of slightly unequal length corresponding to the difference in length between the opposite sides of the light housing.

Retaining straps 14 may be manufactured from material which is identical to that of cross harness 12, however, this is not necessarily the case. It is envisioned that a portion of straps 14 may be colored, for example to compliment a vehicle color, or alternatively, it may be covered with a reflective or fluorescent material. A flat metal or nylon or otherwise rigid cover mount such as hook 30 is secured to one end of strap 14 by riveting or the like, for a total of four hooks 30 on straps 14. Hook 30 may be substantially narrower than strap 14. In such case, the narrow width of hook 30 enables it to be most easily mounted to a wire lens guard or to the openings or mounting apertures provided in solid, transparent lens guards. As seen in FIG. 6, metal hook 30 may incorporate a safety catch 32 manufactured from spring steel or the like. Separate portions 36 and 38 of a hook and loop fastener material such as Velcro™ are mounted or fastened to retaining strap 14 along the end of the strap, opposite to the hook and on a side of the strap opposite to that of the curvature of hook 30, although shown on the same side in FIG. 5 with a cut away break in between.

During installation the retaining straps 14 are first attached to the protective lens guard 26. Guard 26 is then positioned in contact with the lens 24 of light housing 22 and nylon cross-harness 12 is positioned near the rear side 22a of light housing 22. In succession, the distal end of each of the elongated retaining straps 14 is inserted through ring 20, secured to the distal ends 16 of each arm 12a and 12b of cross-harness 12, until the lens guard 26 is snugged into firm contact with lens 24 of the light housing 22. Retaining straps 14 are then folded toward the lens guard 26 until they overlap each other. They are then pressed firmly together to engage the hook and loop fastener portions, to thereby secure them firmly in place and to thereby firmly position the lens guard 26 in place against lens 24.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A lens guard retaining device for retaining a cover over a lens mounted to a light housing, said device comprising:
a criss-cross array of at least first and second flexible straps, each flexible strap of said first and second flexible straps having oppositely disposed cover mounts mounted at opposite ends thereof, said cover mounts adapted to releasably engage with edges of the cover when adjacent the lens and said array wrapped around a back of the housing opposite the lens, said each flexible strap including a strap tensioning means therealong for releasable tensioning of said each flexible strap once said cover mounts are engaged with the cover, said array thereby selectively and releasably tensionable onto and over the back of the housing to evenly tension the cover onto the lens.

2. The device of claim 1 wherein said array includes a “+”-shaped web.

3. The device of claim 3 wherein said web includes a central cross harness at the center of said web, and wherein each of said first and second flexible straps includes a pair of flexible retaining straps releasably mounted, so as to be oppositely disposed, to opposite ends of said cross harness, said cover mounts at distal ends of said retaining straps when mounted to said cross harness.

4. The device of claim 3 wherein said strap tensioning means includes a buckle mounted on each end of said cross harness and a length of one end of each of said retaining straps journalled through a corresponding said buckle so as to buckle said retaining straps to said cross harness.

5. The device of claim 4 wherein said lengths of said ends of retaining straps have hook and loop fasteners mounted thereto for releasable buckling of said retaining straps to said cross harness.

6. The device of claim 5 wherein said cover mounts are hooks.

7. The device of claim 6 wherein said buckles are rings.

8. The device of claim 7 wherein said rings are rectangular.

9. The device of claim 6 wherein said retaining straps have a width and wherein said hooks are narrower than said width of said retaining straps.

10. The device of claim 6 wherein said hooks further comprise safety clips to resiliently hold closed said hooks so as to releasably latch said hooks onto the edges of the cover when mounted over the lens.
